(19) United States
(12) Patent Application Publication
(10) Pub. No.: US 2024/0392916 A1
(43) Pub. Date: Nov. 28, 2024

(54) MOUNTING BRACKET FOR THERMOSTAT

(71) Applicant: Tyco Fire & Security GmbH, Neuhausen am Rheinfall (CH)

(72) Inventors: Richard David Friend, Southampton, PA (US); Daniel I. Disch, Brookfield, WI (US); Sayan Chakraborty, Brookfield, WI (US); Christopher P. Brophy, Cedarburg, WI (US)

(21) Appl. No.: 18/673,289

(22) Filed: May 23, 2024

Related U.S. Application Data
(60) Provisional application No. 63/468,714, filed on May 24, 2023.

(51) Int. Cl. F16M 13/02; F24F 11/50

(52) U.S. Cl. CPC F16M 13/02; F24F 11/50

(57) ABSTRACT

The present disclosure discloses a mounting bracket including a frame, a latch extending from the frame, and a tab provided on the latch. The latch is configured to be received by a latch receiver on the thermostat. The tab is configured to securely engage with a mating feature on the thermostat to hold the thermostat in a non-parallel orientation with respect to the frame.

### CROSS REFERENCE TO RELATED APPLICATIONS

This application claims the benefit of and the priority to U.S. Provisional Patent Application No. 63/468,714, filed May 24, 2023, the entire disclosure of which is incorporated by reference herein.

### BACKGROUND

Heating, ventilating, or air conditioning (HVAC) systems for residential, industrial, and commercial buildings often include a controller, such as a thermostat, installed within the building to monitor temperature and provide control signals to HVAC equipment. The thermostats may display information to a user on a user interface including a display. The display may be provided directly on the thermostat. The information on the display may be provided in a segmented-display format or using a pixel format.

A thermostat is preferably mounted on a wall at a specific height from a floor. Before mounting, the thermostat is electrically connected with an HVAC system for facilitating communication between the thermostat and the HVAC system. However, it is difficult to hold the thermostat, and simultaneously, establish a connection between the thermostat and electrical wiring coming out through the wall.

Therefore, there is a need of a mounting bracket that facilitates mounting of the thermostat as well as supports the thermostat during wiring.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building equipped with a HVAC system, according to an exemplary embodiment.

FIG. 2 is a schematic drawing of multiple zones and floors of the building of FIG. 1 equipped with control devices, according to an exemplary embodiment.

FIG. 3 is a schematic block diagram of a waterside system that may be used in conjunction with the building of FIGS. 1-2, according to an exemplary embodiment.

FIG. 4 is a schematic block diagram of an airside system that may be used in conjunction with the building of FIGS. 1-2, according to an exemplary embodiment.

FIG. 5 is a schematic drawing of the connections of the control device of FIG. 2 and FIG. 4, according to an exemplary embodiment.

FIG. 6 is a schematic diagram of a communications system located in the building of FIGS. 1 and 2, according to an exemplary embodiment.

FIG. 7 is a schematic block diagram illustrating the control device of FIGS. 2, 3, and 5 in greater detail, according to an exemplary embodiment.

FIG. 8 is a schematic block diagram of a thermostat in a residence according to an exemplary embodiment.

FIG. 9 is a schematic view of a mounting bracket, according to one aspect of the present disclosure.

FIG. 10 is another schematic view of the mounting bracket in a portrait orientation, according to some embodiments.

FIG. 11 is another schematic view of the mounting bracket in a landscape orientation, according to some embodiments.

FIG. 12 and FIG. 13 are schematic views depicting engagement between the mounting bracket and a thermostat.

FIG. 14 is an enlarged view of the mounting bracket, according to some embodiments.

FIG. 15 is another enlarged view of the mounting bracket, according to some embodiments.

FIG. 16 is a schematic view of the mounting bracket depicting indications and level indicators, according to some embodiments.

FIG. 17 is another schematic view of the mounting bracket depicting the level indicators at a rear surface of the mounting bracket, according to some embodiments.

FIG. 18 is another schematic view of the mounting bracket depicting the level indicators at a front surface of the mounting bracket, according to some embodiments.

FIG. 19 is another schematic view of the mounting bracket depicting an elongated screw slot, according to some embodiments.

FIGS. 20-29 depict operative configuration of the mounting bracket in a portrait orientation.

FIGS. 30-39 depict operative configuration of the mounting bracket in a landscape orientation.

FIG. 40 and FIG. 41 are schematic views of the mounting bracket, according to another aspect of the present disclosure.

### DETAILED DESCRIPTION

### Overview

The present disclosure discloses a mounting bracket including a frame, a latch extending from the frame, and a tab provided on the latch. The latch is configured to be received by a latch receiver on the thermostat. The tab is configured to securely engage with a mating feature on the thermostat to hold the thermostat in a non-parallel orientation with respect to the frame.

In some embodiments, the tab is received by the latch receiver along with the latch in response to the movement of the thermostat in a first direction with respect to the frame. The tab is configured to securely engage with the mating feature, proximate to the latch receiver, on the thermostat in response to a subsequent movement of the thermostat in a second direction with respect to the frame.

In some embodiments, the first direction is orthogonal to the second direction.

In some embodiments, the tab is orthogonal to the latch.

In some embodiments, the latch is received by the latch receiver provided on a side of the thermostat in the non-parallel orientation.

In some embodiments, the latch is further configured to be received in an opening provided on a rear surface of the thermostat to mount the thermostat in a parallel orientation with respect to the frame.

In some embodiments, the tab includes a bump formed on a surface thereof. In some embodiments, the bump contacts the mating feature and creates an area of increased pressure when the tab securely engages with the mating feature.

In some embodiments, the bracket includes one or more bumps formed on a front surface of the frame to securely hold the thermostat.

In some embodiments, the mounting bracket is mountable in a portrait orientation or a landscape orientation. In the portrait orientation, the latch defines a top or a bottom of the mounting bracket, and the tab protrudes sidewards from the latch. In the landscape orientation, the latch defines a left side or a right side of the mounting bracket, and the tab protrudes upwards from the latch.

In some embodiments, the bracket includes one or more indications formed on a front surface of the frame and to indicate at least one of the portrait orientation and the landscape orientation of the mounting bracket.

In some embodiments, the bracket includes at least two level indicators. A first level indicator is configured to indicate a leveled position during mounting of the bracket in the landscape orientation. A second level indicator is configured to indicate another leveled position during mounting of the bracket in the portrait orientation.

In some embodiments, the first and second level indicators protrude from a rear surface of the frame. In some other embodiments, the first and second level indicators protrude from a front surface of the frame.

In some embodiments, the frame includes an elongated screw slot to provide a range of adjustment for the bracket with a mounting surface.

According to another aspect, a thermostat includes a housing and a mounting bracket. The housing has a latch receiver and a mating feature. The mounting bracket securely holds the housing during set up. The mounting bracket includes a frame, a latch protruding from the frame, and a tab provided on the latch. The latch is configured to be received by the latch receiver in response to a movement of the housing in a first direction with respect to the frame. The tab is configured to securely engage with the mating feature in response to a subsequent movement of the housing in a second direction with respect to the frame.

According to yet another aspect, the thermostat includes a thermostat housing and a mounting bracket. The mounting bracket is hingeably coupled to the thermostat housing to maintain the thermostat in a first configuration for facilitating setup of the thermostat and in a second configuration for facilitating operation of the thermostat.

According to yet another aspect, a thermostat includes a thermostat housing and a mounting bracket. The mounting bracket includes a first level indicator in a horizontal direction and a second level indicator in a vertical direction.

### System Overview

### Building Management System and HVAC System

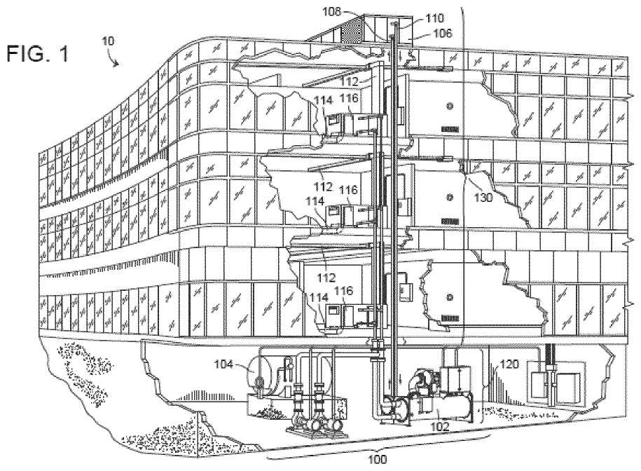

Referring now to FIGS. 1-4, an exemplary building management system (BMS) and HVAC system in which the systems and methods of the present disclosure may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, and any other system that is capable of managing building functions or devices, or any combination thereof.

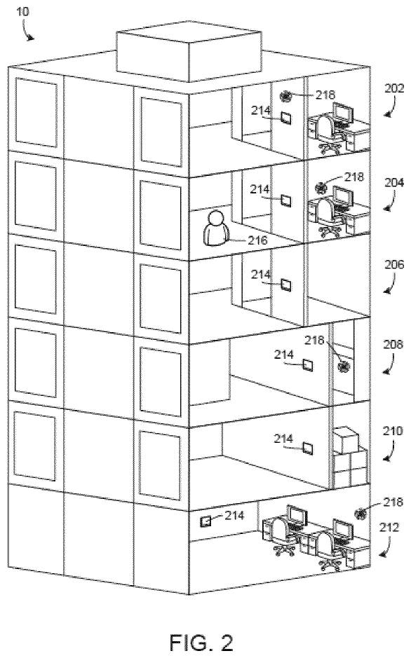

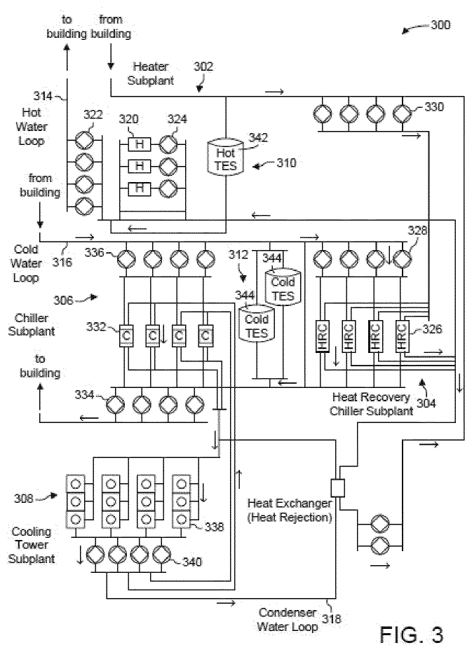

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, building 10 is shown in greater detail, according to an exemplary embodiment. Building 10 may have multiple zones. In FIG. 2, building 10 has zones, 202, 204, 206, 208, 210, and 212. In building 10, the zones each correspond to a separate floor. In various embodiments, the zones of building 10 may be rooms, sections of a floor, multiple floors, etc. Each zone may have a corresponding control device 214. In some embodiments, control device 214 is at least one of a thermostat, a sensor, a controller, a display device, a concierge device, a medical monitor device, etc. Control device 214 may take input from users. The input may be an environmental setpoint, a concierge question, a payment, etc. In some embodiments, control device 214 can cause music and/or building announcements to be played in one or more of zones 202-212, cause the temperature and/or humidity to be regulated in one or more of zones 202-212, and/or any other control action.

In some embodiments, control device 214 can monitor the health of an occupant 216 of building 10. In some embodiments, control device 214 monitors heat signatures, heartrates, and any other information that can be collected from cameras, medical devices, and/or any other health related sensor. In some embodiments, building 10 has wireless transmitters 218 in each or some of zones 202-212. The wireless transmitters 218 may be routers, coordinators, and/or any other device broadcasting radio waves. In some embodiments, wireless transmitters 218 form a Wi-Fi network, a Zigbee network, a Bluetooth network, and/or any other kind of network.

In some embodiments, occupant 216 has a mobile device that can communicate with wireless transmitters 218. Control device 214 may use the signal strengths between the mobile device of occupant 216 and the wireless transmitters 218 to determine in which zone the occupant is. In some embodiments, control device 214 causes temperature setpoints, music and/or other control actions to follow occupant 216 as the occupant 216 moves from one zone to another zone (i.e., from one floor to another floor).

In some embodiments, control devices 214 are connected to a building management system, a weather server, and/or a building emergency sensor(s). In some embodiments, control devices 214 may receive emergency notifications from the building management system, the weather server, and/or the building emergency sensor(s). Based on the nature of the emergency, control devices 214 may give directions to an occupant of the building. In some embodiments, the direction may be to respond to an emergency (e.g., call the police, hide, and turn the lights off, etc.) In various embodiments, the directions given to the occupant (e.g., occupant 216) may be navigation directions. For example, zone 212 may be a safe zone with no windows an individual (e.g., occupant 216). If control devices 214 determines that there are high winds around building 10, the control device 214 may direct occupants of zones 202-210 to zone 212 if zone 212 has no windows.

Referring now to FIG. 3, a block diagram of a waterside system 300 is shown, according to an exemplary embodiment. In various embodiments, waterside system 300 may supplement or replace waterside system 120 in HVAC system 100 or may be implemented separate from HVAC system 100. When implemented in HVAC system 100, waterside system 300 may include a subset of the HVAC devices in HVAC system 100 (e.g., boiler 104, chiller 102, pumps, valves, etc.) and may operate to supply a heated or chilled fluid to AHU 106. The

HVAC devices of waterside system 300 may be located within building 10 (e.g., as components of waterside system 120) or at an offsite location such as a central plant.

In FIG. 3, waterside system 300 is shown as a central plant having a plurality of subplants 302-312. Subplants 302-312 are shown to include a heater subplant 302, a heat recovery chiller subplant 304, a chiller subplant 306, a cooling tower subplant 308, a hot thermal energy storage (TES) subplant 310, and a cold thermal energy storage (TES) subplant 312. Subplants 302-312 consume resources (e.g., water, natural gas, electricity, etc.) from utilities to serve the thermal energy loads (e.g., hot water, cold water, heating, cooling, etc.) of a building or campus. For example, heater subplant 302 may be configured to heat water in a hot water loop 314 that circulates the hot water between heater subplant 302 and building 10. Chiller subplant 306 may be configured to chill water in a cold water loop 316 that circulates the cold water between chiller subplant 306 building 10. Heat recovery chiller subplant 304 may be configured to transfer heat from cold water loop 316 to hot water loop 314 to provide additional heating for the hot water and additional cooling for the cold water. Condenser water loop 318 may absorb heat from the cold water in chiller subplant 306 and reject the absorbed heat in cooling tower subplant 308 or transfer the absorbed heat to hot water loop 314. Hot TES subplant 310 and cold TES subplant 312 may store hot and cold thermal energy, respectively, for subsequent use.

Hot water loop 314 and cold water loop 316 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 302-312 to receive further heating or cooling.

Although subplants 302-312 are shown and described as heating and cooling water for circulation to a building, it is understood that any other type of working fluid (e.g., glycol, CO2, etc.) may be used in place of or in addition to water to serve the thermal energy loads. In other

embodiments, subplants 302-312 may provide heating and/or cooling directly to the building or campus without requiring an intermediate heat transfer fluid. These and other variations to waterside system 300 are within the teachings of the present disclosure.

Each of subplants 302-312 may include a variety of equipment configured to facilitate the functions of the subplant. For example, heater subplant 302 is shown to include a plurality of heating elements 320 (e.g., boilers, electric heaters, etc.) configured to add heat to the hot water in hot water loop 314. Heater subplant 302 is also shown to include several pumps 322 and 324 configured to circulate the hot water in hot water loop 314 and to control the flow rate of the hot water through individual heating elements 320. Chiller subplant 306 is shown to include a plurality of chillers 332 configured to remove heat from the cold water in cold water loop 316. Chiller subplant 306 is also shown to include several pumps 334 and 336 configured to circulate the cold water in cold water loop 316 and to control the flow rate of the cold water through individual chillers 332.

Heat recovery chiller subplant 304 is shown to include a plurality of heat recovery heat exchangers 326 (e.g., refrigeration circuits) configured to transfer heat from cold water loop 316 to hot water loop 314. Heat recovery chiller subplant 304 is also shown to include several pumps 328 and 330 configured to circulate the hot water and/or cold water through heat recovery heat exchangers 326 and to control the flow rate of the water through individual heat recovery heat exchangers 226. Cooling tower subplant 308 is shown to include a plurality of cooling towers 338 configured to remove heat from the condenser water in condenser water loop 318. Cooling tower subplant 308 is also shown to include several pumps 340 configured to circulate the condenser water in condenser water loop 318 and to control the flow rate of the condenser water through individual cooling towers 338.

Hot TES subplant 310 is shown to include a hot TES tank 342 configured to store the hot water for later use. Hot TES subplant 310 may also include one or more pumps or valves configured to control the flow rate of the hot water into or out of hot TES tank 342. Cold TES subplant 312 is shown to include cold TES tanks 344 configured to store the cold water for later use. Cold TES subplant 312 may also include one or more pumps or valves configured to control the flow rate of the cold water into or out of cold TES tanks 344.

In some embodiments, one or more of the pumps in waterside system 300 (e.g., pumps 322, 324, 328, 330, 334, 336, and/or 340) or pipelines in waterside system 300 include an isolation valve associated therewith. Isolation valves may be integrated with the pumps or positioned upstream or downstream of the pumps to control the fluid flows in waterside system 300. In various embodiments, waterside system 300 may include more, fewer, or different types of devices and/or subplants based on the particular configuration of waterside system 300 and the types of loads served by waterside system 300.

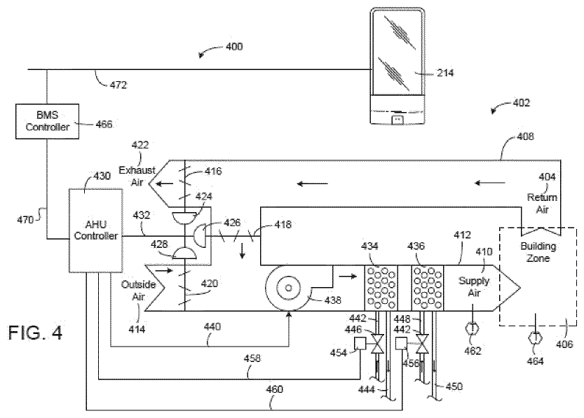

Referring now to FIG. 4, airside system 400 is shown to include an economizer-type air handling unit (AHU) 402. Economizer-type AHUs vary the amount of outside air and return air used by the air handling unit for heating or cooling. For example, AHU 402 may receive return air 404 from building zone 406 via return air duct 408 and may deliver supply air 410 to building zone 406 via supply air duct 612. In some embodiments, AHU 402 is a rooftop unit located on the roof of building 10 (e.g., AHU 402 as shown in FIG. 1) or otherwise positioned to receive both return air 404 and outside air 414. AHU 402 may be configured to operate exhaust air damper 416, mixing damper 418, and outside air damper 420 to control an amount of outside air 414 and return air 404 that combine to form supply air 410. Any return air 404 that does not pass through mixing damper 418 may be exhausted from AHU 402 through exhaust damper 416 as exhaust air 422.

Each of dampers 416-420 may be operated by an actuator. For example, exhaust air damper 416 may be operated by actuator 424, mixing damper 418 may be operated by actuator 426, and outside air damper 420 may be operated by actuator 428. Actuators 424-428 may communicate with an AHU controller 430 via a communications link 432. Actuators 424-428 may receive control signals from AHU controller 430 and may provide feedback signals to AHU controller 430. Feedback signals may include, for example, an indication of a current actuator or damper position, an amount of torque or force exerted by the actuator, diagnostic information (e.g., results of diagnostic tests performed by actuators 424-428), status information, commissioning information, configuration settings, calibration data, and/or other types of information or data that may be collected, stored, or used by actuators 424-428. AHU controller 430 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 424-428.

Still referring to FIG. 4, AHU 402 is shown to include a cooling coil 434, a heating coil 436, and a fan 438 positioned within supply air duct 612. Fan 438 may be configured to force supply air 410 through cooling coil 434 and/or heating coil 436 and provide supply air 410 to building zone 406. AHU controller 430 may communicate with fan 438 via communications link 440 to control a flow rate of supply air 410. In some embodiments, AHU controller 430 controls an amount of heating or cooling applied to supply air 410 by modulating a speed of fan 438.

Cooling coil 434 may receive a chilled fluid from waterside system 200 (e.g., from cold water loop 316) via piping 442 and may return the chilled fluid to waterside system 200 via piping 444. Valve 446 may be positioned along piping 442 or piping 444 to control a flow rate of the chilled fluid through cooling coil 474. In some embodiments, cooling coil 434 includes multiple stages of cooling coils that can be independently activated and deactivated (e.g., by AHU controller 430, by BMS controller 466, etc.) to modulate an amount of cooling applied to supply air 410.

Heating coil 436 may receive a heated fluid from waterside system 200 (e.g., from hot water loop 314) via piping 448 and may return the heated fluid to waterside system 200 via piping 450. Valve 452 may be positioned along piping 448 or piping 450 to control a flow rate of the heated fluid through heating coil 436. In some embodiments, heating coil 436 includes multiple stages of heating coils that can be independently activated and deactivated (e.g., by AHU controller 430, by BMS controller 466, etc.) to modulate an amount of heating applied to supply air 410.

Each of valves 446 and 452 may be controlled by an actuator. For example, valve 446 may be controlled by actuator 454 and valve 452 may be controlled by actuator 456. Actuators 454-456 may communicate with AHU controller 430 via communications links 458-460. Actuators 454-456 may receive control signals from AHU controller 430 and may provide feedback signals to controller 430. In some embodiments, AHU controller 430 receives a measurement of the supply air temperature from a temperature sensor 462 positioned in supply air duct 612 (e.g., downstream of cooling coil 434 and/or heating coil 436). AHU controller 430 may also receive a measurement of the temperature of building zone 406 from a temperature sensor 464 located in building zone 406.

In some embodiments, AHU controller 430 operates valves 446 and 452 via actuators 454-456 to modulate an amount of heating or cooling provided to supply air 410 (e.g., to achieve a set point temperature for supply air 410 or to maintain the temperature of supply air 410 within a set point temperature range). The positions of valves 446 and 452 affect the amount of heating or cooling provided to supply air 410 by cooling coil 434 or heating coil 436 and may correlate with the amount of energy consumed to achieve a desired supply air temperature. AHU controller 430 may control the temperature of supply air 410 and/or building zone 406 by activating or deactivating coils 434-436, adjusting a speed of fan 438, or a combination of both.

Still referring to FIG. 4, airside system 400 is shown to include a building management system (BMS) controller 466 and a control device 214. BMS controller 466 may include one or more computer systems (e.g., servers, supervisory controllers, subsystem controllers, etc.) that serve as system level controllers, application or data servers, head nodes, or master controllers for airside system 400, waterside system 200, HVAC system 100, and/or other controllable systems that serve building 10. BMS controller 466 may communicate with multiple downstream building systems or subsystems (e.g., HVAC system 100, a security system, a lighting system, waterside system 200, etc.) via a communications link 470 according to like or disparate protocols (e.g., LON, BACnet, etc.). In various embodiments, AHU controller 430 and BMS controller 466 may be separate (as shown in FIG. 4) or integrated. In an integrated implementation, AHU controller 430 may be a software module configured for execution by a processor of BMS controller 466.

In some embodiments, AHU controller 430 receives information from BMS controller 466 (e.g., commands, set points, operating boundaries, etc.) and provides information to BMS controller 466 (e.g., temperature measurements, valve or actuator positions, operating statuses, diagnostics, etc.). For example, AHU controller 430 may provide BMS controller 466 with temperature measurements from temperature sensors 462-464, equipment on/off states, equipment operating capacities, and/or any other information that can be used by BMS controller 466 to monitor or control a variable state or condition within building zone 406.

Control device 214 may include one or more of the user control devices. Control device 214 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Control device 214 may be a computer workstation, a client terminal, a remote or local interface, or any other type of user interface device. Control device 214 may be a stationary terminal or a mobile device. For example, control device 214 may be a desktop computer, a computer server with a user interface, a laptop computer, a tablet, a smartphone, a PDA, or any other type of mobile or non-mobile device. Control device 214 may communicate with BMS controller 466 and/or AHU controller 430 via communications link 472.

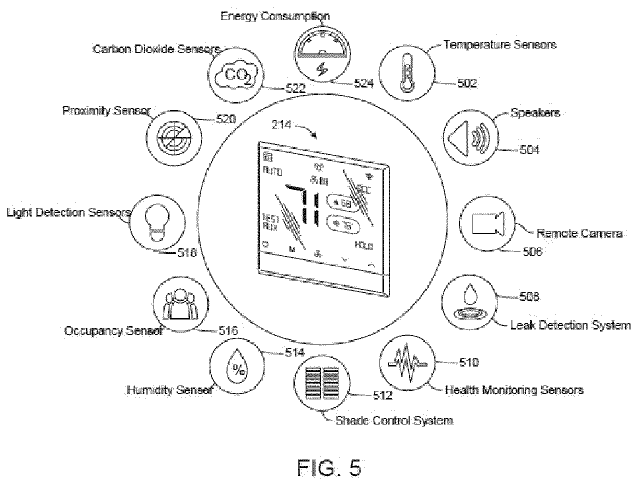

Referring now to FIG. 5, control device 214 is shown as a connected smart hub or private area network (PAN), according to some embodiments. Control device 214 may include a variety of sensors and may be configured to communicate with a variety of external systems or devices. For example, control device 214 may include temperature sensors 502, speakers 504, leak detection system 508, health monitoring sensors 510, humidity sensors 514, occupancy sensors 516, light detection sensors 518, proximity sensor 520, carbon dioxide sensors 522, or any of a variety of other sensors. Alternatively, control device 214 may receive input from external sensors configured to measure such variables. The external sensors may not communicate over a PAN network but may communicate with control device 214 via an IP based network and/or the Internet.

In some embodiments, speakers 504 are located locally as a component of control device 214. Speakers 504 may be low power speakers used for playing audio to the immediate occupant of control device 214 and/or occupants of the zone in which control device 214 is located. In some embodiments, speakers 504 may be remote speakers connected to control device 214 via a network. In some embodiments, speakers 504 are a building audio system, an emergency alert system, and/or alarm system configured to broadcast building wide and/or zone messages or alarms.

Control device 214 may communicate with a remote camera 506, a shade control system 512, a leak detection system 508, a HVAC system, or any of a variety of other external systems or devices which may be used in a home automation system or a building automation system. Control device 214 may provide a variety of monitoring and control interfaces to allow a user to control all of the systems and devices connected to control device 214. Exemplary user interfaces and features of control device 214 are described in greater detail below.

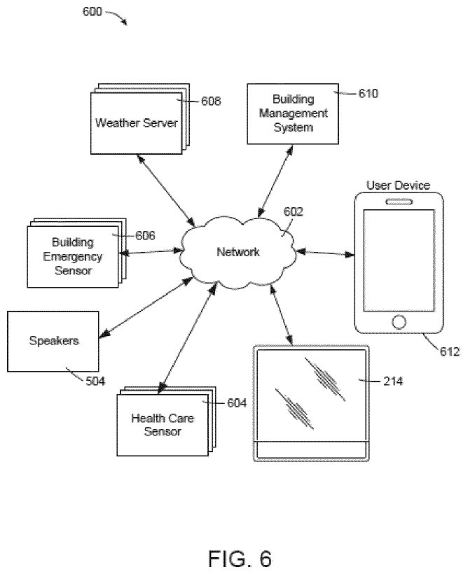

Referring now to FIG. 6, a block diagram of communications system 600 is shown, according to an exemplary embodiment. System 600 can be implemented in a building (e.g. building 10) and is shown to include control device 214, network 602, healthcare sensor(s) 604, building emergency sensor(s) 606, weather server(s) 608, building management system 610, and user device 612. System 600 connects devices, systems, and servers via network 602 so that building information, HVAC controls, emergency information, navigation directions, and other information can be passed between devices (e.g., control device 214, user device 612, and/or building emergency sensor(s) 606 and servers and systems (e.g., weather server(s) 608 and/or building management system 610). In some embodiments, control device 214 is connected to speakers 504 as described with reference to FIG. 5.

In some embodiments, network 602 communicatively couples the devices, systems, and servers of system 600. In some embodiments, network 602 is at least one of and/or a combination of a Wi-Fi network, a wired Ethernet network, a ZigBee network, and a Bluetooth network. Network 602 may be a local area network or a wide area network (e.g., the Internet, a building WAN, etc.) and may use a variety of communications protocols (e.g., BACnet, IP, LON, etc.) Network 602 may include routers, modems, and/or network switches. The devices in system 600 including the control device 214 can include a software interface such as Open Blue Bridge which live connection between the physical and digital replicas, enabling data exchange for seamless communication and action. The software interface can be executed on processing platform on the edge device (e.g., control device 214) and provide digital twinning on the control device for device 214 and other sensors or equipment in system 600. The software interface also allows artificial intelligence (AI) application to be executed in the edge device and perform data analytics. Data analytics and a software interface are discussed in U.S. application Ser. No. 17/134,691, filed Dec. 28, 2020, incorporated herein by reference in its entirety and assigned to the assignee of the present application.

In some embodiments, control device 214 is configured to receive emergency information, navigation directions, occupant information, concierge information, and any other information via network 602. In some embodiments, the information is received from building management system 610 via network 602. In various embodiments, the information is received from the Internet via network 602. In some embodiments, control device 214 is at least one of or a combination of a thermostat, a humidistat, a light controller, and any other wall mounted and/or handheld device. In some embodiments, control device 214 is connected to building emergency sensor(s) 606. In some embodiments, building emergency sensor(s) 606 are sensors which detect building emergencies. Building emergency sensor(s) 606 may be smoke detectors, carbon monoxide detectors, carbon dioxide detectors (e.g., carbon dioxide sensors 522), an emergency button (e.g., emergency pull handles, panic buttons, a manual fire alarm button and/or handle, etc.) and/or any other emergency sensor. In some embodiments, the emergency sensor(s) include actuators. The actuators may be building emergency sirens and/or building audio speaker systems (e.g., speakers 504), automatic door and/or window control (e.g., shade control system 512), and any other actuator used in a building.

In some embodiments, control device 214 may be communicatively coupled to weather server(s) 608 via network 602. In some embodiments, the control device 214 may be configured to receive weather alerts (e.g., high and low daily temperature, five-day forecast, thirty-day forecast, etc.) from weather server(s) 608. Control device 214 may be configured to receive emergency weather alerts (e.g., flood warnings, fire warnings, thunderstorm warnings, winter storm warnings, etc.) In some embodiments, control device 214 may be configured to display emergency warnings via a user interface of control device 214 when control device 214 receives an emergency weather alert from weather server(s) 608. The control device 214 may be configured to display emergency warnings based on the data received from building emergency sensor(s) 606. In some embodiments, the control device 214 may cause a siren (e.g., speakers 504 and/or building emergency sensor(s) 606) to alert occupants of the building of an emergency, cause all doors to become locked and/or unlocked, cause an advisory message be broadcast through the building, and control any other actuator or system necessary for responding to a building emergency.

In some embodiments, control device 214 is configured to communicate with building management system 610 via network 602. Control device 214 may be configured to transmit environmental setpoints (e.g., temperature setpoint, humidity setpoint, etc.) to building management system 610. In some embodiments, building management system 610 may be configured to cause zones of a building (e.g., building 10) to be controlled to the setpoint received from control device 214. In some embodiments, building management system 610 may be configured to control the lighting of a building. In some embodiments, building management system 610 may be configured to transmit emergency information to control device 214. In some embodiments, the emergency information is a notification of a shooter lockdown, a tornado warning, a flood warning, a thunderstorm warning, and/or any other warning. In some embodiments, building management system 610 is connected to various weather servers or other web servers from which building management system 610 receives emergency warning information. In various embodiments, building management system is a computing system of a hotel. Building management system 610 may keep track of hotel occupancy, may relay requests to hotel staff, and/or perform any other functions of a hotel computing system.

Control device 214 is configured to communicate with user device 612 via network 602. In some embodiments, user device 612 is a smartphone, a tablet, a laptop computer, and/or any other mobile and/or stationary computing device. In some embodiments, user device 612 communicates calendar information to control device 214. In some embodiments, the calendar information is stored and/or entered by a user into a calendar application. In some embodiments, calendar application is at least one of Outlook, Google Calendar, Fantastical, Shifts, CloudCal, DigiCal, and/or any other calendar application. In some embodiments, control device 214 receives calendar information from the calendar application such as times and locations of appointments, times, and locations of meetings, and/or any other information. Control device 214 may be configured to display building map direction to a user associated with user device 612 and/or any other information.

In some embodiments, a user may press a button on a user interface of control device 214 indicating a building emergency. The user may be able to indicate the type of emergency (e.g., fire, flood, active shooter, etc.) Control device 214 may communicate an alert to building management system 610, user device 612, and any other device, system, and/or server.

In some embodiments, control device 214 is communicably coupled to healthcare sensor(s) 604 via network 602. In some embodiments, control device 214 is configured to monitor healthcare sensor(s) 604 collecting data for occupants of a building (e.g., building 10) and determine health metrics for the occupants based on the data received from the healthcare sensor(s) 604. In some embodiments, healthcare sensor(s) 604 are one or more smart wrist bands, pacemakers, insulin pumps, and/or any other medical device. The health metrics may be determined based on heart rates, insulin levels, and/or any other biological and/or medical data.

In some embodiments, user device 612 is configured to provide one or templates for storage on control device 214. The templates define icons and locations as well as location for text information on control device. The templates are created in application software for the user device 612 (e.g., a mobile device, cell phone, etc.). In some embodiments, backgrounds for each template can be selected. Templates include logo templates including customer or supplier logos and non-logo templates. Templates can be selected for specific buildings, rooms, environments (e.g., hospital, store, hotel, home, etc.) Some templates may be created for visually impaired or for different languages. Some templates may be for carbon emission/footprint monitoring, measuring, scoring (e.g., versus others, standards, or targets), and include icons dedicated to these applications (e.g., a green leaf having a size indicating green compliance, air quality warnings and icons indicating air quality, sustainability icons and settings, etc.).

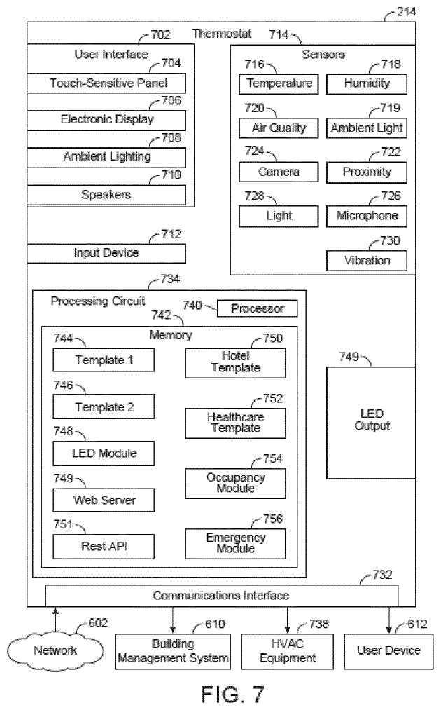

Referring now to FIG. 7, a block diagram illustrating control device 214 in greater detail is shown, according to some embodiments. Control device 214 is shown to include a variety of user interface devices 702 and sensors 714 and is embodied as a commercial or residential thermostat. User interface devices 702 may be configured to receive input from a user and provide output to a user in various forms. For example, user interface devices 702 are shown to include electronic display 706 (e.g., pixelated display), ambient lighting 708, speakers 710 (e.g., speakers 504), and input device 712. In some embodiments, user interface devices 702 include a microphone configured to receive voice commands from a user, a keyboard or buttons, switches, dials, or any other user-operable input devices. It is contemplated that user interface devices 702 may include any type of device configured to receive input from a user and/or provide an output to a user in any of a variety of forms (e.g., touch, text, video, graphics, audio, vibration, etc.).

Sensors 714 may be configured to measure a variable state or condition of the environment in which control device 214 is installed. For example, sensors 714 are shown to include a temperature sensor 716, a humidity sensor 718, an ambient light sensor 719, an air quality sensor 720, a proximity sensor 722, a camera 724, a microphone 726, a light sensor 728, and a vibration sensor 730. In some embodiments, one more of sensors 714 is not provided (e.g., microphone 726 and camera 724). Air quality sensor 720 may be configured to measure any of a variety of air quality variables such as oxygen level, carbon dioxide level, carbon monoxide level, allergens, pollutants, smoke, etc. Proximity sensor 722 may include one or more sensors configured to detect the presence of people or devices proximate to control device 214. For example, proximity sensor 722 may include a near-field communications (NFC) sensor, a radio frequency identification (RFID) sensor, a Bluetooth sensor, a capacitive proximity sensor, a biometric sensor, or any other sensor configured to detect the presence of a person or device. Camera 724 may include a visible light camera, a motion detector camera, an infrared camera, an ultraviolet camera, an optical sensor, or any other type of camera. Light sensor 728 may be configured to measure ambient light levels. Vibration sensor 730 may be configured to measure vibrations from earthquakes or other seismic activity at the location of control device 214.

Still referring to FIG. 7, control device 214 is shown to include a communications interface 732 and a processing circuit 734. Communications interface 732 may include wired or wireless interfaces (e.g., jacks, antennas, transmitters, receivers, transceivers, wire terminals, etc.) for conducting data communications with various systems, devices, or networks. For example, communications interface 732 may include an Ethernet card and port for sending and receiving data via an Ethernet-based communications network and/or a Wi-Fi transceiver for communicating via a wireless communications network. Communications interface 732 may be configured to communicate via local area networks or wide area networks (e.g., the Internet, a building WAN, etc.) and may use a variety of communications protocols (e.g., BACnet, IP, LON, etc.).

Communications interface 732 may include a network interface configured to facilitate electronic data communications between control device 214 and various external systems or devices (e.g., network 602, building management system 610, HVAC equipment 738, user device 612, etc.) For example, control device 214 may receive information from building management system 610 or HVAC equipment 738 indicating one or more measured states of the controlled building (e.g., temperature, humidity, electric loads, etc.) and one or more states of the HVAC equipment 738 (e.g., equipment status, power consumption, equipment availability, etc.). In some embodiments, HVAC equipment 738 may be lighting systems, building systems, actuators, chillers, heaters, and/or any other building equipment and/or system. The communication interface 732 between HVAC equipment 738 is a three wire (power, ground a communication) or four wire (power, communication 1, communication 2, and ground, B, G, Y, R or W or O/B, C, K, R) connection in some embodiments. Communications interface 732 may receive inputs from building management system 610 or HVAC equipment 738 and may provide operating parameters (e.g., on/off decisions, set points, etc.) to building management system 610 or HVAC equipment 738. The operating parameters may cause building management system 610 to activate, deactivate, or adjust a set point for various types of home equipment or building equipment in communication with control device 214.

Processing circuit 734 is shown to include a processor 740 and memory 742. Processor 740 may be a general purpose or specific purpose processor, an application specific integrated circuit (ASIC), one or more field programmable gate arrays (FPGAs), a group of processing components, or other suitable processing components. Processor 740 may be configured to execute computer code or instructions stored in memory 742 or received from other computer readable media (e.g., CDROM, network storage, a remote server, etc.). Processing circuit 734 adjusts the brightness of the electronic display 706 based upon ambient light sensed by ambient light sensor 719 or weather information received via network 602.

Memory 742 may include one or more devices (e.g., memory units, memory devices, storage devices, etc.) for storing data and/or computer code for completing and/or facilitating the various processes described in the present disclosure. Memory 742 may include random access memory (RAM), read-only memory (ROM), hard drive storage, temporary storage, non-volatile memory, flash memory, optical memory, or any other suitable memory for storing software objects and/or computer instructions. Memory 742 may include database components, object code components, script components, or any other type of information structure for supporting the various activities and information structures described in the present disclosure. Memory 742 may be communicably connected to processor 740 via processing circuit 734 and may include computer code for executing (e.g., by processor 740) one or more processes described herein. For example, memory 742 includes a template 1 744, a template 2 746, a light control module 748, a hotel template 750, a health care template 752, an occupancy module 754, and an emergency module 756. The operation of some of these modules is described in greater detail below.

In some embodiments, template 1 744, template 2 746, hotel template 750, and health care template 752 provide the configuration for the user interface displayed on display 706. Icon placement, control selectors on the touch screen or touch sensitive panel 704, and background colors or images are stored in template 1 744, template 2, 746, a hotel template 750, a health care template 752 in some embodiments. Template 1 744, template 2 746, hotel template 750, and health care template 752 are user configurable via an app on a mobile device (e.g., user device 612 (FIG. 6)) in some embodiments. The hotel template 750 and a health care template 752 may be configured to provide particular icons, controls and backgrounds for hotel and healthcare applications, respectively. In some embodiments, the templates 1 744, template 2 746, hotel template 750, and health care template 752 include a selectable background and the background is a picture or other image. Templates can be received from external sources over API or other communication modes-wired/wirelessly. A template download can be provided from a mobile app or from a personal computer. Designer can choose what to display on the thermostat (template design with available standard parameters like setpoint, sensor reading, background, font color, etc.).

Light control module 748 controls light output 749 (e.g., LED output) to provide a light associated with an operating mode (idle, heat, cool. or emergency). The light output 749 can provide a color, flash, strobe in pattern, etc. to indicate a condition. For example, a red color can indicate a heat mode, a blue color can indicate a cool mode, a flashing orange can indicate an emergency or fault, and white or yellow can indicate an idle mode. Based on message received from the network or internal logic, user can configure the color of the light output 749 (e.g., one or more LEDs) and flashing pattern. For example, when it is a time to replace a filter, the light output 749 turns Yellow and flashes at constant or configurable interval or if there is a message from the facility manager to control device 214 and the message is not read yet, the light output 749 turns cyan.

The light output 749 includes one or more color light emitting diodes in some embodiments. Processing circuit 734 also controls display brightness in response to signals from ambient light sensor 719, time of day/season and/or weather information received from network 602.

### Residential HVAC System

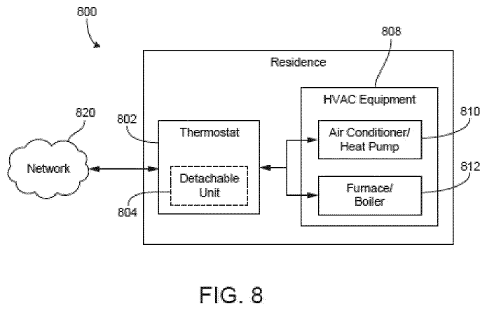

Referring now to FIG. 8, a thermostat 802 for controlling building equipment such as HVAC equipment 808 in a residence 800 is shown, according to an exemplary embodiment. The thermostat 802 includes a display 803 and a detachable unit 804 and can provide the operations of control device 214 (FIG. 7) for the systems illustrated in FIGS. 1-4 or the residence 800. The display 503 may be an interactive pixelated display (liquid crystal display (LCD)) and touch screen that can display variable information to a user and receive input from the user.

HVAC equipment 808 provides heated and/or cooled air to residence 800 in some embodiments. Although described with respect to residence 800, embodiments of the systems and methods described herein can be utilized in a cooling unit or a heating unit in a variety of applications include commercial HVAC units (e.g., roof top units). In general, a residence 800 includes refrigerant conduits that operatively couple an indoor unit to an outdoor unit of air conditioner/heat pump 810. Indoor unit may be positioned in a utility space, an attic, a basement, and so forth. Outdoor unit is situated adjacent to a side of residence 800. Refrigerant conduits transfer refrigerant between indoor unit and outdoor unit, transferring primarily liquid refrigerant in one direction and primarily vaporized refrigerant in an opposite direction. A furnace/boiler 812 or heat pump of the air conditioner/heat pump 810 is controlled to provide heat to the residence 800. Thermostat 802 is in communication with network 820 via a wired local network or wireless network in some embodiments.

The thermostat 802 is configured to generate control signals for HVAC equipment 808 via a wired or wireless communication link. In various embodiments, the thermostat 802 generates control signals for the HVAC equipment 808 based on the indoor ambient temperature (e.g., measured via indoor ambient temperature sensor), the outdoor temperature (e.g., measured via the outdoor ambient temperature sensor), and/or a temperature set point and provides the control signal via detachable unit 804. In various embodiments, the thermostat 802 provides visual indicia of the operating modes, the setpoint, and the indoor or outdoor temperature on the display 803. The detachable unit 804 provides thermostat functions and can include various sensors, power circuits, interfaces, and other non-display components of a thermostat.

Detachable unit 804 provides the control signals for the HVAC equipment vie a three or four wire connection in some embodiments. The detachable unit 804 receives the control signals or data indicative of the control signals wirelessly or via a wired connection from display 803 in some embodiments.

### Mounting Bracket for Thermostat

Preferably, a thermostat is mounted on a wall at a specific height, for example, 4 to 5 feet, above a floor. The wall may have an opening such that, communication wires may be provided in the opening. One end of the communication wires may be attached to an HVAC system to which the thermostat is to be connected, while other end of the wires may be suspended freely in the opening on the wall. In some embodiments, the thermostat may be wirelessly coupled to the HVAC system.

A wall box may be provided in the opening of the wall. A mounting bracket is attached to the wall box. In some cases, the mounting bracket may be directly attached to the wall. The thermostat is attached to the mounting bracket. Before mounting the thermostat onto the wall, a setup of thermostat needs to be completed. The setup may include a step of establishing a communication between the thermostat and the HVAC system. For establishing the communication, free end of the wiring in the opening is connected to the thermostat. Preferably, connection facility is provided at a back side of the thermostat to which the wiring can be connected. While connecting the wires, the thermostat needs to be held securely so that the wires can be connected at ease.

Brackets are known in the art that facilitates the setup of the thermostat. Such brackets include a clip that can temporarily hold the thermostat during the setup, for example, during connecting communication wires to the thermostat. However, the clip is unable to prevent movement of the thermostat in a direction orthogonal to a wall onto which the thermostat is to be mounted. Due to this, the thermostat may slip from the bracket while the setup is in progress, which is undesirable.

The present disclosure discloses a mounting bracket that facilitates secure holding of the thermostat during a setup.

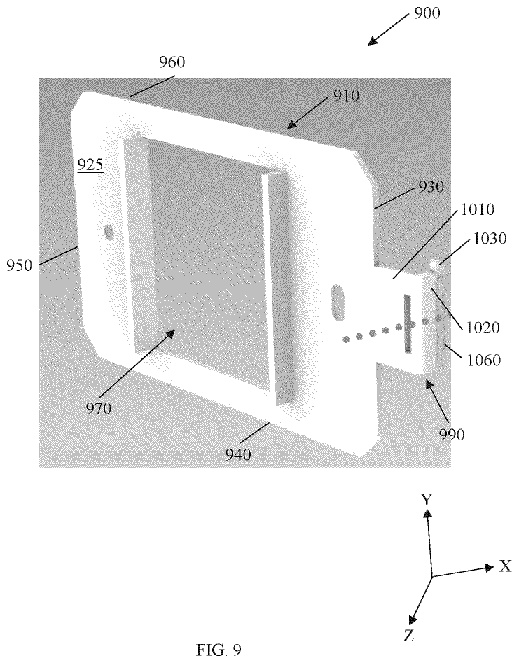

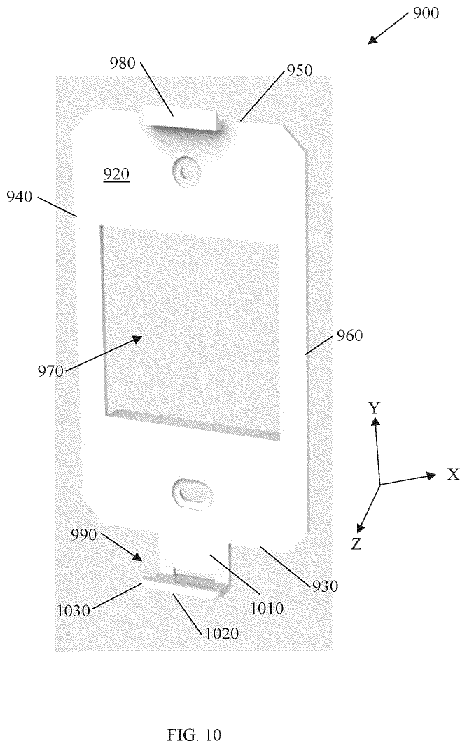

Referring to FIGS. 9 and 10, a mounting bracket 900 is shown according to some embodiments of the present disclosure. The mounting bracket 900 has a frame 910 having a front surface 920 and a rear surface 925. Hereinafter, the terms “mounting bracket 900” and “bracket 900” are used interchangeably. The front surface 920 acts as a mounting surface, and the rear surface 925 is attached to a wall. The bracket 900 may have a substantially rectangular shape defined by a first side 930, a second side 940, a third side 950, and a fourth side 960. The sides 930-960 may have chamfered corners. The first side 930 and the third side 950 are parallel, whereas the second side 940 and the fourth side 960 are parallel. In some embodiments, the first side 930 and the third side 950 have equal lengths, whereas the second side 940 and the fourth side 960 are equal in lengths. The first side 930 and the third side 950 may be shorter than the second side 940 and the fourth side 960. However, the bracket 900 is not limited to rectangular shape and four sides, and can have any other suitable shape, number of sides, and orientations in other embodiments.

The frame 910 has an opening 970 that is configured to align with an opening in a wall when the bracket 900 is mounted on the wall. Preferably, the bracket 900 is attached to a wall box provided in the opening of the wall.

The bracket 900 includes a hook 980 extending from the frame 910. Preferably, the hook 980 extends from the front surface 920 of the frame 910. The hook 980 is inserted into an opening provided on a rear surface of a thermostat (e.g., control device) when the thermostat is mounted on the bracket 900 in a mounting configuration. The hook 980 can be provided at any suitable location on the frame 910.

In FIG. 10, the bracket 900 is shown in a portrait orientation. In the portrait orientation, the hook 980 may define a top of the bracket 900. However, the hook 980 can be provided at any other suitable location on the frame 910. For example, the hook 980 can be provided at substantial middle portion of the frame 910. In some other examples, the hook 980 can be provided at sides of the frame 910.

In the portrait orientation shown in FIG. 10, the first side 930 defines a bottom, whereas the third side 950 defines a top of the bracket 900. The hook 980 may be provided at or proximal to the third side 950.

The bracket 900 may include a latch 990 provided to securely hold a thermostat during a setup configuration. In the setup configuration, wiring of the thermostat can be accomplished. The latch 990 may extend from the first side 930 of the frame 910. In some other embodiments, the latch 990 may extend from any other suitable portion of the frame 910.

The latch 990 may extend orthogonally from the frame 910. For example, as shown in FIG. 10, the frame 910 may have the front surface 920 in X-Y plane, whereas the latch 990 extends in Y-Z plane. A free end of the latch 990 may extend in a direction away from the frame 910 and opposite to a wall onto which the bracket 900 is fitted.

The latch 990 can have any suitable configuration. In some embodiments, the latch 990 may have an extension 1010 extending from the first side 930 in a downward direction. The latch 990 may have a lock 1020 extending orthogonally from the extension 1010 away from the frame 910 and opposite to a wall onto which the bracket 900 is fitted. In the setup configuration, the lock 1020 of the latch 990 may be inserted into a thermostat. In some embodiments, the lock 1020 of the latch 990 may be inserted into the thermostat when the thermostat is mounted on the bracket 900 in operative configuration. Thus, the latch 990 facilitates both holding the thermostat during setup and securing the thermostat to the bracket 900 in the operative configuration.

In some other embodiments, the latch 990 may have the lock 1020 extending from the first side 930. In some other embodiments, the latch 990 may extend from any other portion of the frame 910 apart from the first side 930. For example, the latch 990 may extend from the second side 940 or the fourth side 960 of the frame 910.

In some embodiments, the extension 1010 and the lock 1020 may be integrally formed with the frame 910. In some embodiments, one of or all of the extension 1010, the lock 1020, and the frame 910 may be separately formed and connected with each other.

The bracket 900 includes a tab 1030 provided to temporarily lock a thermostat to restrict movement of the thermostat in Y-Z plane. The tab 1030 may extend from the latch 990 orthogonally. The tab 1030 may extend towards the second side 940 (as shown in FIG. 10) or may extend towards the fourth side 960.

In some embodiments, the latch 990 may include a snap feature 1060 provided on the lock 1020. The snap feature 1060 facilitates easy insertion of the latch 990 into a thermostat while the thermostat is mounted on the bracket 900 in an operative configuration of the thermostat.

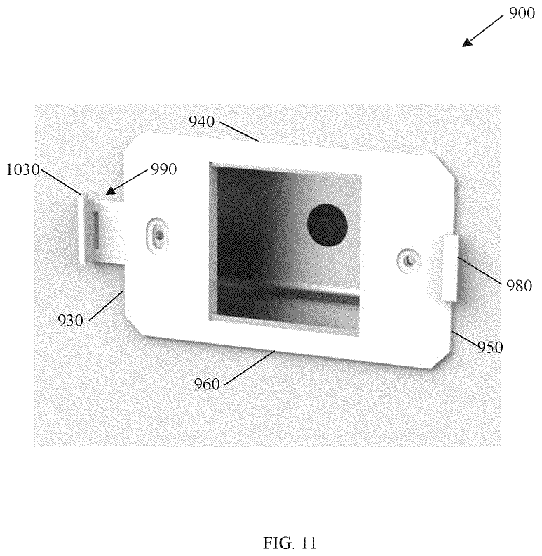

Referring to FIG. 11, a landscape orientation of the bracket 900 is shown. The bracket 900 may be employed in the landscape orientation by rotating the bracket 900 in the portrait orientation (as shown in FIG. 10) by 90° in a clockwise or an anticlockwise direction. The landscape orientation of the bracket 900 shown in FIG. 11 can be obtained by rotating the bracket 900 in the portrait orientation (as shown in FIG. 10) by 90° in the clockwise direction. It is to be noted that the portrait or landscape orientation are defined according to shape of the bracket 900. The bracket 900 of the present disclosure is not limited to the portrait or the landscape orientation, and can be used in any other suitable orientation depending upon shape and size of the bracket 900.

As shown in FIG. 11, in the landscape orientation, the first side 930 and the third side 950 define a right side and a left side of the bracket 900 respectively, whereas the second side 940 and the fourth side 960 define the top and the bottom of the bracket 900 respectively. The latch 990 may be provided on the first side 930 or the third side 950 defining the right side and the left side of the bracket 900 respectively. In some embodiments, the latch 990 may be provided on the second side 940 or the fourth side 960.

The tab 1030 may extend towards the second side 940. More specifically, the tab 1030 extends in an upward direction. In case the tab 1030 is extending towards the fourth side 960, the bracket 900 in the portrait orientation is rotated such that the tab 1030 extends in the upward direction in the landscape orientation of the bracket 900.

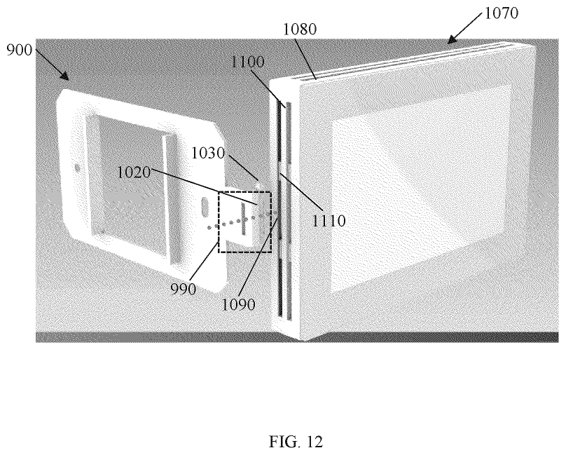

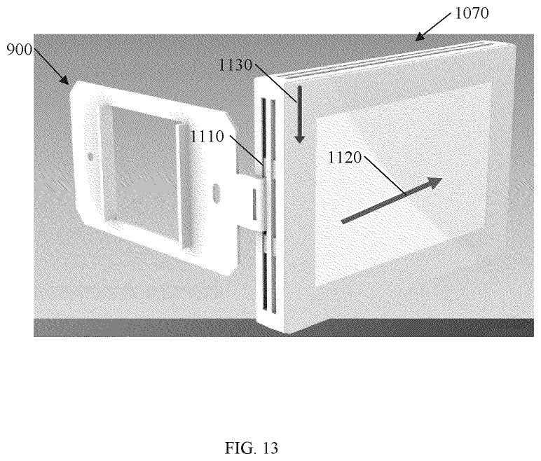

Referring to FIG. 12 and FIG. 13, locking between the bracket 900 and a thermostat 1070 in a setup configuration is elaborated, according to some embodiments. In the setup configuration, the thermostat 1070 is locked with the latch 990. The thermostat 1070 includes a housing 1080 having a latch receiver 1090 configured to receive the latch 990 during the setup of the thermostat 1070. The latch receiver 1090 can be provided on the housing 1080 at any suitable location based on locking position of the thermostat 1070. In some embodiments, as shown in FIG. 12, the latch receiver 1090 is provided at a side 1100 of the thermostat 1070. The latch receiver 1090 may be an opening sufficiently wide to receive the latch 990 and the tab 1030. The housing 1080 further includes a mating feature 1110 provided to securely engage with the tab 1030 such that motion of the thermostat 1070 is restricted in a direction shown by an arrow 1120. The mating feature 1110 may be provided proximate to the latch receiver 1090.

The latch 990 facilitate temporary locking between the bracket 900 and the thermostat 1070. To temporary lock the thermostat 1070 with the bracket 900, initially, the thermostat 1070 is moved towards the bracket 900 such that the latch receiver 1090 is aligned with the lock 1020. The thermostat 1070 is advanced further till the lock 1020 is received in the latch receiver 1090. Once the lock 1020 is sufficiently received in the latch receiver 1090, the thermostat 1070 is displaced in a direction 1130 opposite to direction of extension of the tab 1030 till the mating feature 1110 is engaged with the tab 1030. The mating feature 1110 prevents movement of the tab 1030 out of the housing 1080 until the tab 1030 is disengaged from the mating feature 1110. In some embodiments, the mating feature 1110 can be a partition. Due to this, the thermostat 1070 is temporarily locked with the bracket 900. Further, setup of the thermostat 1070 may be completed including completion of wiring and connections of the thermostat 1070. The thermostat 1070 can be unlocked from the bracket 900 by displacing the thermostat in a direction opposite to the direction 1130 and further displacing the thermostat 1070 away from the bracket 900.

The thermostat 1070 can be secured to the bracket 900 using the latch 990 and the tab 1030 such that the thermostat 1070 is non-parallel to the bracket 900 for setup of the thermostat 1070. In some embodiments, the thermostat 1070 can be orthogonal to the bracket 900. An angle between the thermostat 1070 and the bracket 900 can be altered by altering angle between the lock 1020 and the frame 910. For example, the lock 1020 can be orthogonal to the frame 910 resulting in the thermostat 1070 being secured to the bracket 900 orthogonally.

In some embodiments, the tab 1030 may have a snap feature such that the tab 1030 gets locked with the housing 1080 when the thermostat 1070 receives the lock 1020. More specifically, the tab 1030 travels into the latch receiver 1090 along with the lock 1020 and engages with the mating feature 1110. Due to this, the thermostat 1070 is not required to move in the direction 1130 to engage the tab 1030 and the mating feature 1110. To unlock, a cavity may be provided on the housing 1080 to facilitate insertion of a tool that disengages the tab 1030 from the housing 1080, more specifically, from the mating feature 1110.

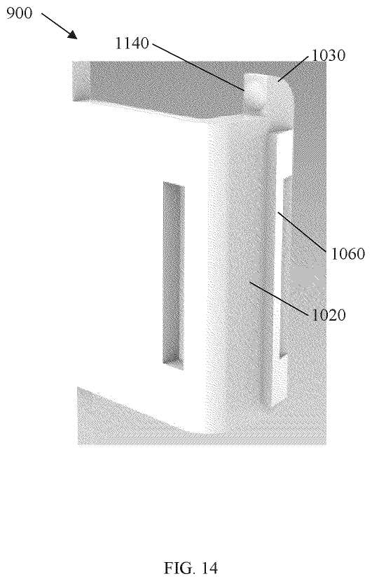

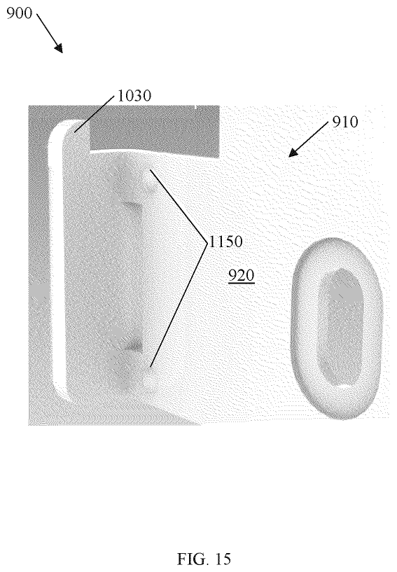

Referring to FIG. 14, one or more pressure bumps 1140 may be provided on the tab 1030 to facilitate pressure fit or friction fit between the tab 1030 and the housing 1080 of the thermostat 1070. The bump 1140 contacts the mating feature 1110 and creates an area of increased pressure when the tab 1030 securely engages with the mating feature 1110. Similarly, referring to FIG. 15, one or more pressure bumps 1150 may be provided on the front surface 920 of the frame 910 to facilitate pressure fit or friction fit between the frame 910 and the housing 1080 of the thermostat 1070.

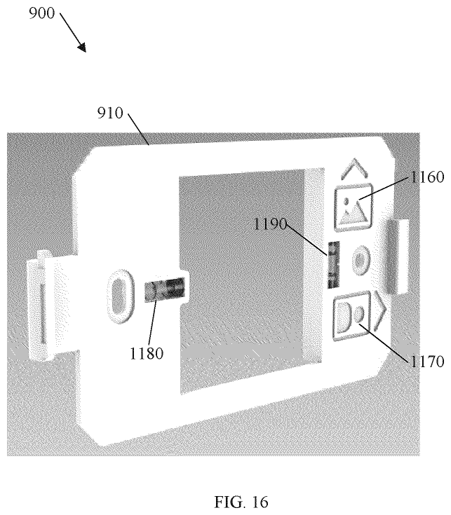

Referring to FIG. 16, the frame 910 may include one or more indications to indicate at least one of a portrait orientation and a landscape orientation. For example, the frame 910 may include a first indication 1160 for indicating a landscape orientation and a second indication 1170 for indicating a portrait orientation of the bracket 900. The indications 1160, 1170 may include directional arrows pointing direction of orientation.

In some embodiments, the bracket 900 may include at least two level indicators 1180, 1190 for indicating a true level of the bracket 900 during mounting the bracket 900 onto a mounting surface, for example, a wall or a wall box. The level indicators 1180, 1190 may be spirit level indicators or any other suitable level indicators. A first level indicator 1180 may be utilized for checking true level of the bracket 900 in a landscape orientation, while a second level indicator 1190 may be utilized for checking true level of the bracket 900 in a portrait orientation.

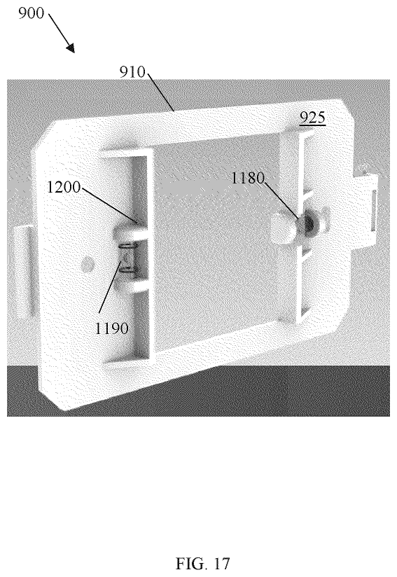

Cavities may be provided on the frame 910 to receive and securely hold the level indicators 1180, 1190. In some embodiments, as shown in FIG. 17, the level indicators 1180, 1190 may protrude out from the rear surface 925 of the frame 910. Ribs 1200 may be provided for supporting the level indicators 1180, 1190 on the frame 910.

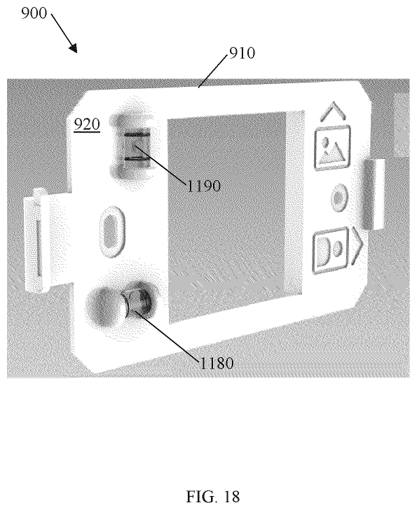

Referring to FIG. 18, one or more level indicators 1180, 1190 may protrude out from the front surface 920 of the frame 910. Appropriate cutouts may be provided on a thermostat to receive protruded portion of the level indicators 1180, 1190.

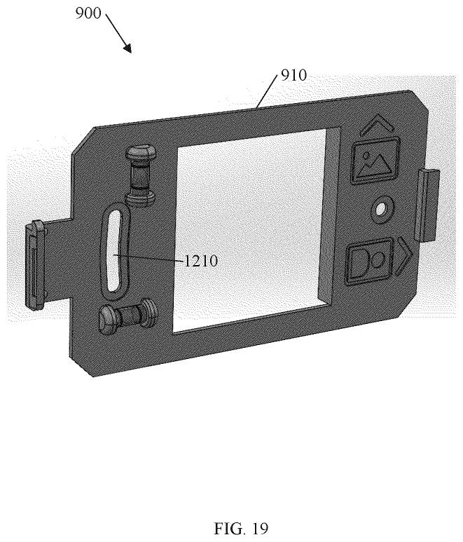

Referring to FIG. 19, the frame 910 may include an elongated shaped screw slot 1210. The screw slot 1210 can be elongated by following a linear path, a curved path, or combination thereof. When the bracket 900 is attached to a wall box, holes on the bracket 900 may mismatch with holes on the mounting surface, for example, a wall box. The elongated screw slot 1210 provided a range for adjustment of a screw with respect to the bracket 900 and the holes on the mounting surface. The elongated screw slot 1210 facilitates travel of the screw through the slot 1210 such that the screw can be aligned with the holes on the mounting surface.

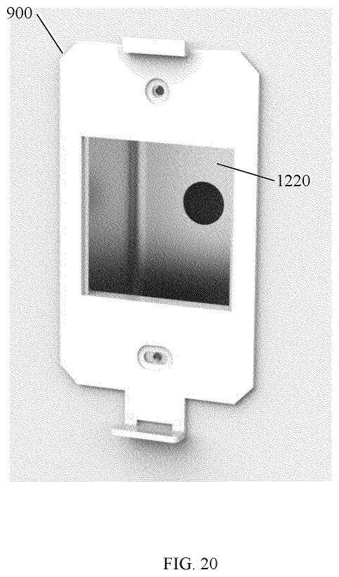

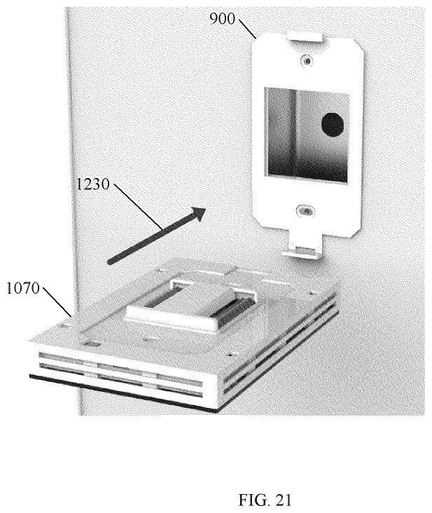

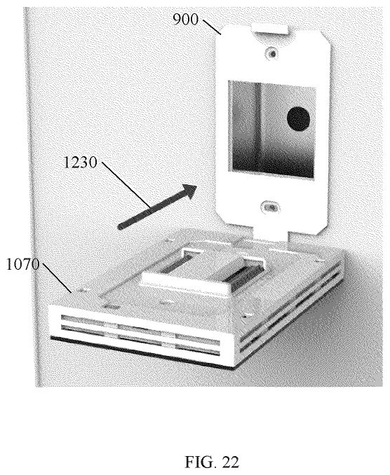

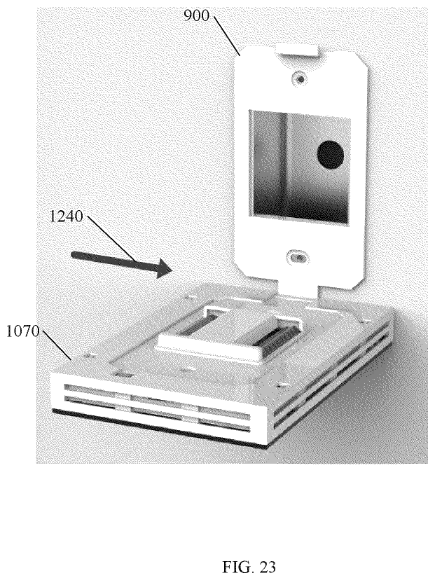

Referring to FIGS. 20-29, operating configuration of the bracket 900 in a portrait orientation is explained. Referring to FIG. 20, initially, the bracket 900 is attached to a mounting surface, for example, a wall box 1220. The bracket 900 can be in the portrait orientation. Further, as shown in FIG. 21, the thermostat 1070 is moved towards the bracket 900 in a first direction 1230. Orientation of the thermostat 1070 while moving towards the bracket 900 is such that the latch receiver 1090 on the thermostat aligns with the lock 1020 on the bracket 900. Referring to FIG. 22, the thermostat 1070 is moved towards the bracket 900 till the lock 1020 is sufficiently received in the latch receiver 1090. Referring to FIG. 23, the thermostat 1070 is further moved in a second direction 1240. The second direction 1240 may be a direction opposite to a direction of extension of the tab 1030 from the latch 990. The second direction 1240 may be orthogonal to the first direction 1230. Movement of the thermostat 1070 in the second direction 1240 engages the tab 1030 with the mating feature 1110. As a result, movement of the thermostat 1070 in a direction opposite to the first direction 1230 is restricted. A setup of the thermostat 1070 can now be completed as the thermostat 1070 securely rests on the bracket 900. The setup may include connecting wiring with the thermostat 1070. In some embodiments, bracket 900 and thermostat 1070 can be configured so that thermostat 1070 is opened from the opposite side of bracket 900 (e.g., in a top orientation). The hinge and tab can be on opposite sides to effect the configuration in some embodiments.

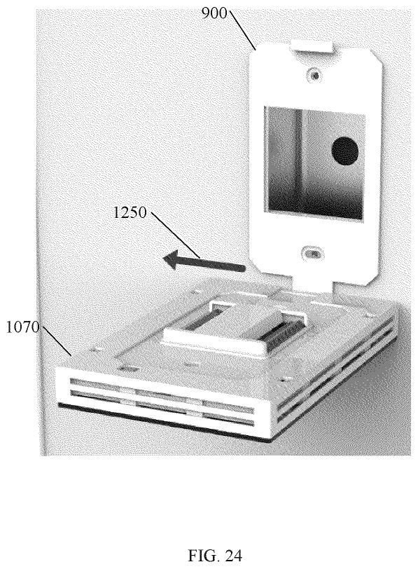

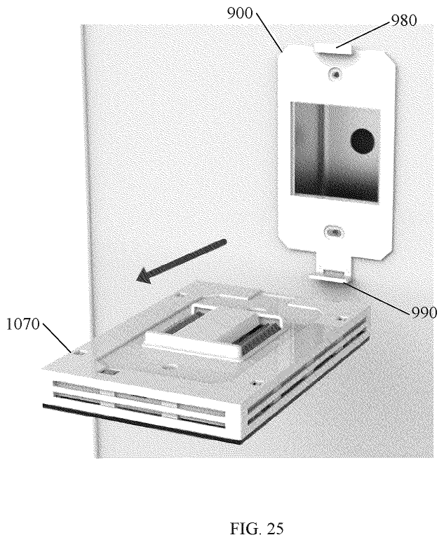

Once setup is completed, the thermostat 1070 is disengaged from the bracket 900. Referring to FIG. 24, the thermostat 1070 is displaced in a third direction 1250 to disengage the tab 1030 from the housing 1080. The third direction 1250 can be opposite to the second direction 1240. Further, as shown in FIG. 25, the thermostat 1070 is moved away from the bracket 900.

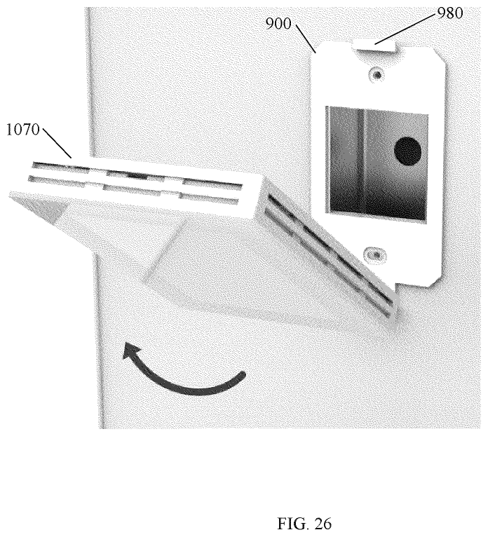

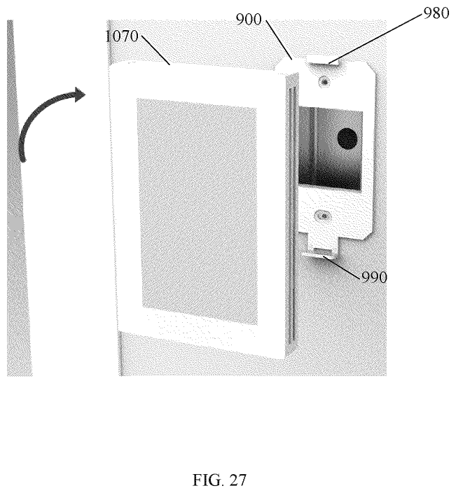

Referring to FIG. 26 and FIG. 27, the thermostat 1070 is rotated such that the thermostat 1070 becomes parallel to the bracket 900. In some embodiments, the thermostat 1070 is mounted on the bracket 900 in a portrait orientation of the thermostat 1070.

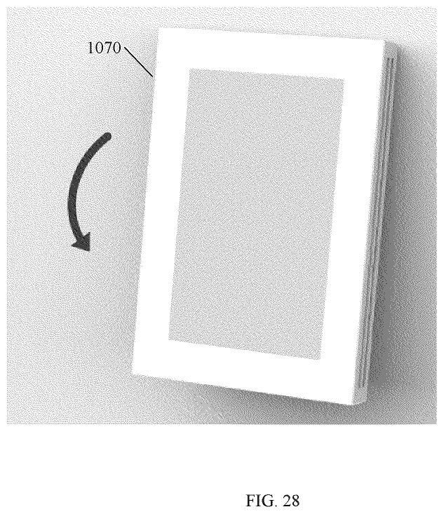

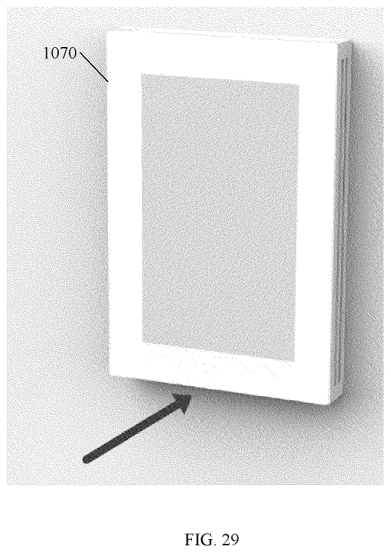

Referring to FIG. 28, the thermostat 1070 is aligned with the hook 980 of the bracket 900. Referring to FIG. 29, the thermostat 1070 is pushed towards the bracket 900 such that the hook 980 is received in an opening provided on a rear surface of the thermostat 1070, and the latch 990 along with the snap feature 1060 is received in another opening provided on the rear surface of the thermostat 1070.

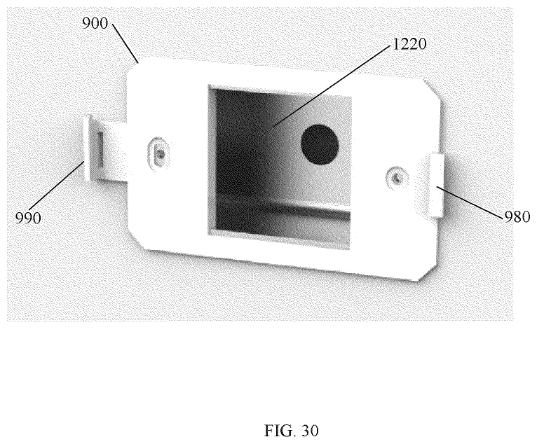

Referring to FIGS. 30-39, operating configuration of the bracket 900 in a landscape orientation is explained.

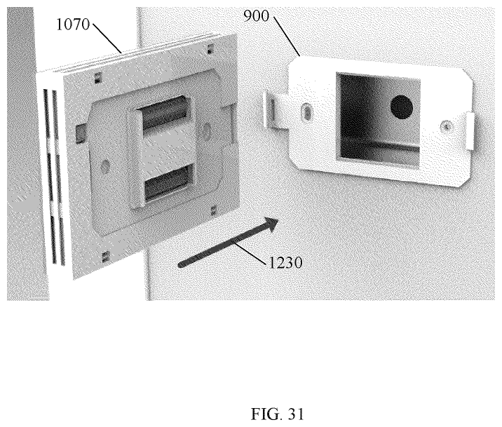

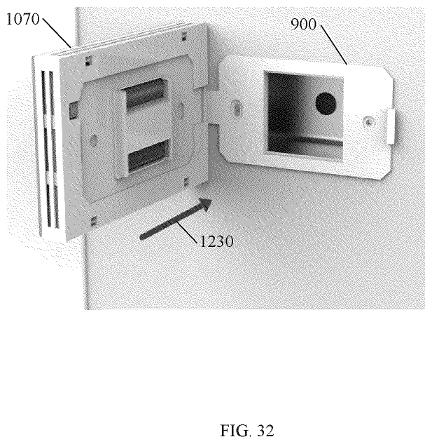

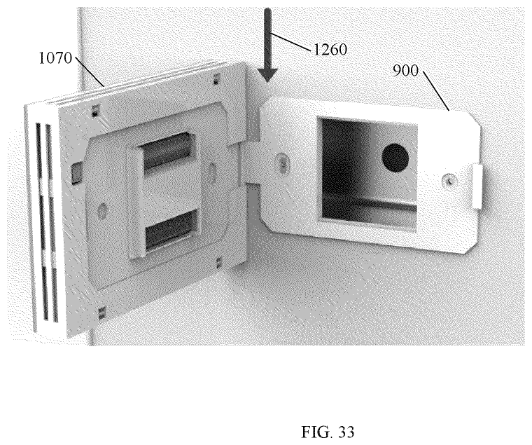

Referring to FIG. 30, initially, the bracket 900 is attached to a mounting surface, for example, the wall box 1220 in the landscape orientation of the bracket 900. Further, as shown in FIG. 31, the thermostat 1070 is moved towards the bracket 900 in the first direction 1230. Orientation of the thermostat 1070 while moving towards the bracket 900 is such that the latch receiver 1090 on the thermostat aligns with the lock 1020 on the bracket 900. Referring to FIG. 32, the thermostat 1070 is moved towards the bracket 900 till the lock 1020 is sufficiently received in the latch receiver 1090. Referring to FIG. 33, the thermostat 1070 is further moved in a second direction 1260. The second direction 1260 may be a direction opposite to a direction of extension of tab 1030 from the latch 990. The second direction 1260 may be orthogonal to the first direction 1230. In some embodiments, the second direction 1260 may be directed downwards. Movement of the thermostat 1070 in the second direction 1260 engages the tab 1030 with the mating feature 1110. As a result, movement of the thermostat 1070 in a direction opposite to the first direction 1230 is restricted. A setup of the thermostat 1070 can now be completed as the thermostat 1070 securely rests on the bracket 900. The setup may include connecting wiring with the thermostat 1070.

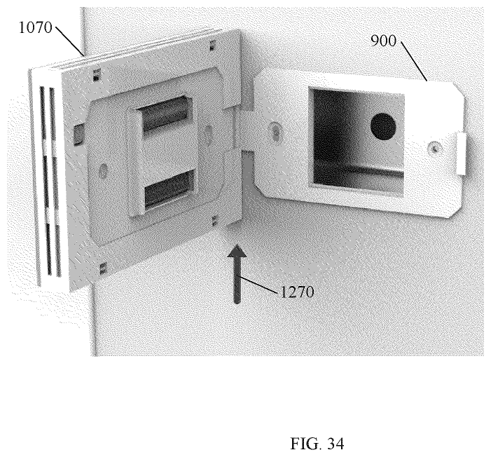

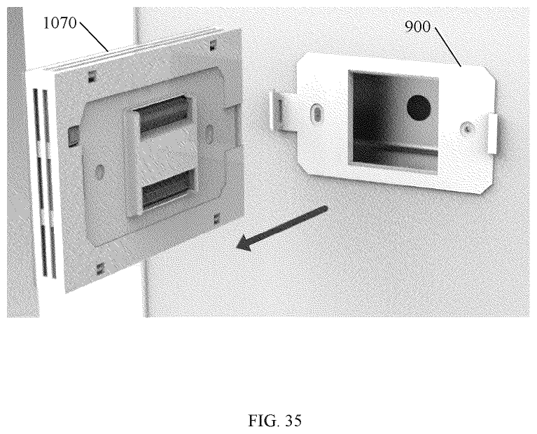

Once setup is completed, the thermostat 1070 is disengaged from the bracket 900. Referring to FIG. 34, the thermostat 1070 is displaced in a third direction 1270 to disengage the tab 1030 from the housing 1080. The third direction 1270 can be opposite to the second direction 1260. The third direction 1270 can be directed upwards. Further, as shown in FIG. 35, the thermostat 1070 is moved away from the bracket 900.

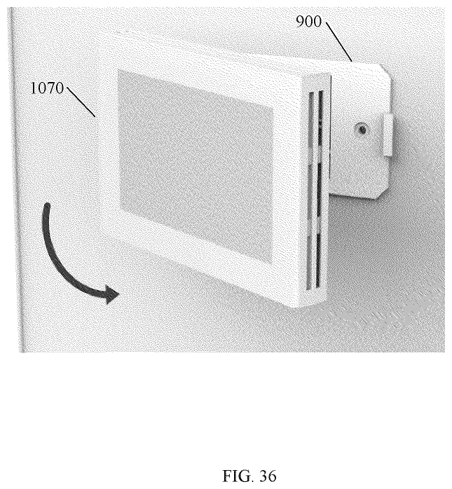

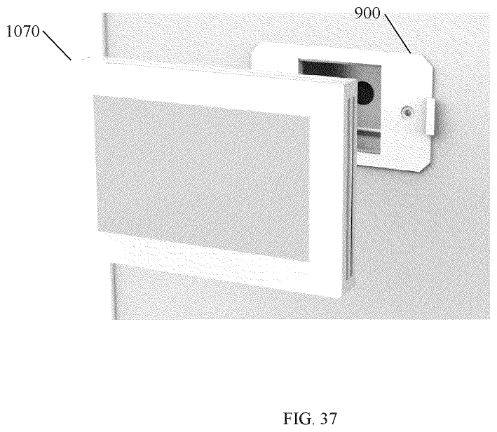

Referring to FIG. 36 and FIG. 37, the thermostat 1070 is rotated such that the thermostat 1070 becomes parallel to the bracket 900. In some embodiments, the thermostat 1070 is mounted on the bracket 900 in the landscape orientation of the thermostat 1070. The mounting of thermostat 1070 on bracket is secure and configured so that installation or other work can be performed without dropping or otherwise disengaging bracket 900 from thermostat 1070 when thermostat 170 is opened with respect to bracket 900 in some embodiments. This secure attachment is available for all embodiments discussed herein.

In some embodiments, bracket 900 and thermostat 1070 can be configured so that thermostat 1070 is opened from the opposite side of bracket 900 (e.g., in a right hand orientation which makes it easier for right handed installers to install wires). The hinge and tab can be on opposite sides to effect the configuration in some embodiments. This right hand configuration is available for all embodiments discussed herein. In some embodiments, bracket 900 includes a terminal block for receiving wires and a pin and receptacle assembly is used to make electrical connections between the wires on bracket 900 and thermostat 1070.

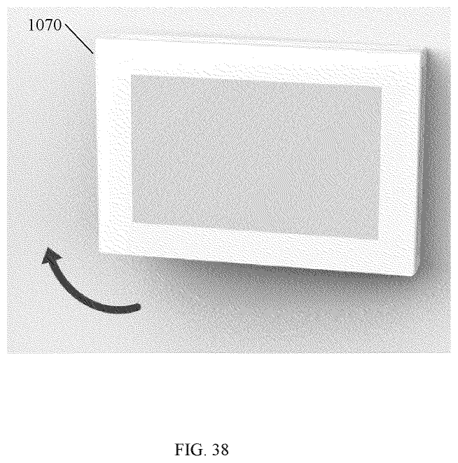

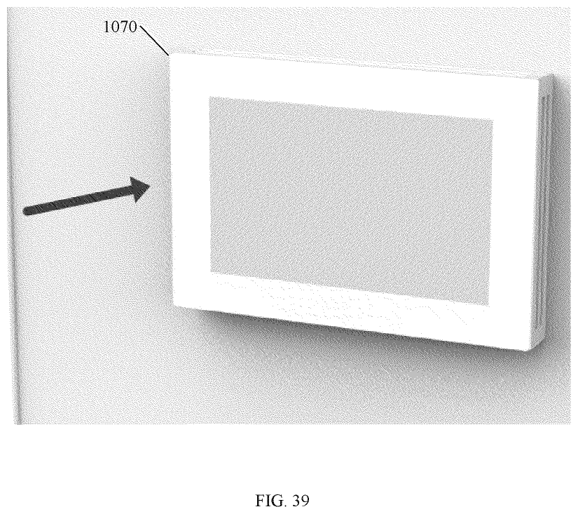

Referring to FIG. 38, the thermostat 1070 is aligned with the hook 980 of the bracket 900. Referring to FIG. 39, the thermostat 1070 is pushed towards the bracket 900 such that the hook 980 is received in an opening provided on a rear surface of the thermostat 1070, and the latch 990 along with the snap feature 1060 is received in another opening provided on the rear surface of the thermostat 1070.

Although the present disclosure described the bracket 900 in a portrait orientation or the landscape orientation, the bracket 900 can be mounted in any other suitable orientation.

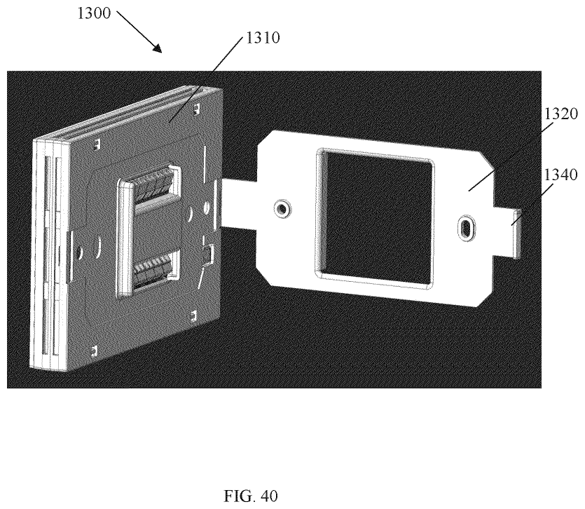

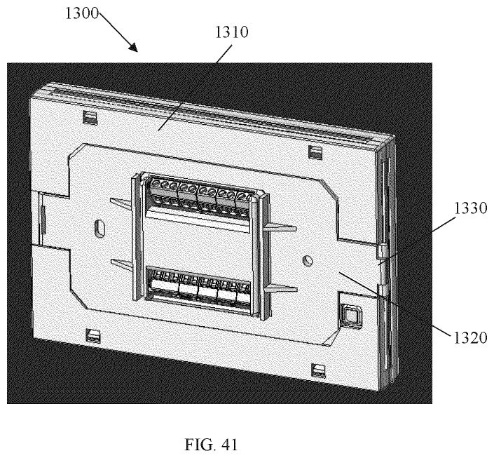

Referring to FIG. 40 and FIG. 41, another aspect of the present disclosure is shown. A thermostat 1300 includes a thermostat housing 1310 and a mounting bracket 1320. The mounting bracket 1320 is coupled to the housing 1310 via a hinge connection 1330. The thermostat 1300 can be mounted on a wall or a wall box by mounting the bracket 1320 onto the wall. The thermostat housing 1310 is rotatable about the hinge connection 1330.

The thermostat 1300 is operable in a first configuration as shown in FIG. 40, wherein the housing 1310 is rotated about the hinge connection 1330 to make the housing 1310 non-parallel to the bracket 1320. In this configuration, wiring or other connections can be completed as a part of setup of the thermostat 1300.

The thermostat 1300 is operable in a second configuration as shown in FIG. 41, wherein the housing 1310 is rotated about the hinge connection 1330 from a position shown in FIG. 40 to make the housing 1310 parallel to the bracket 1320. The bracket 1320 may include a hook 1340 for securing the housing 1310 to the bracket 1320. In this configuration, the thermostat 1300 can be mounted on a wall or a wall box.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A mounting bracket comprising:
a frame;
a latch extending from the frame; and
a tab provided on the latch, the latch configured to be received by a latch receiver on the thermostat, and the tab configured to securely engage with a mating feature on the thermostat to hold the thermostat in a non-parallel orientation with respect to the frame.

2. The mounting bracket of claim 1, wherein the tab is received by the latch receiver along with the latch in response to the movement of the thermostat in a first direction with respect to the frame, and the tab is configured to securely engage with the mating feature, proximate to the latch receiver, on the thermostat in response to a subsequent movement of the thermostat in a second direction with respect to the frame.

3. The mounting bracket of claim 2, wherein the first direction is orthogonal to the second direction.

4. The mounting bracket of claim 1, wherein the tab is orthogonal to the latch.

5. The mounting bracket of claim 1, wherein the latch is received by the latch receiver provided on a side of the thermostat in the non-parallel orientation.

6. The mounting bracket of claim 1, wherein the latch is further configured to be received in an opening provided on a rear surface of the thermostat to mount the thermostat in a parallel orientation with respect to the frame.

7. The mounting bracket of claim 1, wherein the tab comprises a bump formed on a surface thereof.

8. The mounting bracket of claim 7, wherein the bump contacts the mating feature and creates an area of increased pressure when the tab securely engages with the mating feature.

9. The mounting bracket of claim 1, further comprising one or more bumps formed on a front surface of the frame to securely hold the thermostat.

10. The mounting bracket of claim 1, wherein the mounting bracket is mountable in a portrait orientation or a landscape orientation.

11. The mounting bracket of claim 10, wherein in the portrait orientation, the latch defines a top or a bottom of the mounting bracket, and the tab protrudes sidewards from the latch.

12. The mounting bracket of claim 10, wherein in the landscape orientation, the latch defines a left side or a right side of the mounting bracket, and the tab protrudes upwards from the latch.

13. The mounting bracket of claim 10, further comprising one or more indications formed on a front surface of the frame to indicate at least one of the portrait orientation and the landscape orientation of the mounting bracket.

14. The mounting bracket of claim 10, wherein the bracket includes at least two level indicators.

15. The mounting bracket of claim 14, wherein a first level indicator is configured to indicate a leveled position during mounting of the bracket in the landscape orientation and a second level indicator is configured to indicate another leveled position during mounting of the bracket in the portrait orientation.

16. The mounting bracket of claim 15, wherein the first and second level indicators protrude from a rear surface of the frame.

17. The mounting bracket of claim 15, wherein the first and second level indicators protrude from a front surface of the frame.

18. The mounting bracket of claim 1, wherein the frame comprises an elongated screw slot to provide a range of adjustment for the bracket with a mounting surface.

19. A thermostat, comprising:
a housing having a latch receiver and a mating feature proximate to the latch receiver; and
a mounting bracket to securely hold the housing during set up, the mounting bracket comprising:
a frame;
a latch protruding from the frame; and
a tab provided on the latch, the latch configured to be received by the latch receiver in response to a movement of the housing in a first direction with respect to the frame, and the tab configured to securely engage with the mating feature in response to a subsequent movement of the housing in a second direction with respect to the frame.

20. A thermostat comprising:
a thermostat housing; and
a mounting bracket hingeably coupled to the thermostat housing to maintain the thermostat in a first configuration for facilitating setup of the thermostat and in a second configuration for facilitating operation of the thermostat.

21. A thermostat comprising:
a thermostat housing; and
a mounting bracket wherein the mounting bracket comprises a first level indicator in a horizontal direction and a second level indicator in a vertical direction.
